(19) United States
(12) Patent Application Publication
(10) Pub. No.: US 2005/0128509 A1
(43) Pub. Date: Jun. 16, 2005

(54) Image creating method and imaging device

(76) Inventors: Timo Tokkonen, Oulu (FI); Markku Rytivaara, Oulu (FI); Jakke Makela, Turku (FI); Kai Ojala, Oulu (FI); Timo Kolehmainen, Oulu (FI)

Correspondence Address: CRAWFORD MAUNU PLLC, 1270 NORTHLAND DRIVE, SUITE 390, ST. PAUL, MN, 55120, US

(21) Appl. No.: 10/733,784

(22) Filed: Dec. 11, 2003

(51) Int. Cl. G06F 15/00

(52) U.S. Cl. 358/1.15; 358/448

(57) ABSTRACT

A method of creating an image file and an imaging device comprising at least two image capturing apparatus is provided. Each apparatus is arranged to produce an image, wherein at least one first apparatus comprises a color filter matrix of red and blue elements, and at least one second apparatus comprises a green color filter. A controller is arranged to combine the images produced with the apparatus with each other to produce an image with an enhanced image quality.

### FIELD

The invention relates to an imaging device and a method of creating an image file. Especially the invention relates to digital imaging devices comprising more than one image capturing apparatus.

### BACKGROUND

The popularity of photography is continuously increasing. This applies especially to digital photography as the supply of inexpensive digital cameras has improved. Also the integrated cameras in mobile phones have contributed to the increase in the popularity of photography.

The quality of images is naturally important for every photographer. The images obtained with the camera should naturally be sharp and clear and the colors should be balanced. Normally, in digital cameras, color images are taken with a color filter matrix placed in front of the image sensor of the camera. A typical color filter matrix is a Bayer matrix, which comprises a 2×2 grid of color filters. The grid comprises of one red, one blue and two green filters. Each filter covers a pixel in the image sensor. Thus, in the final image, a pixel is calculated using four physical image sensor pixels. Due to the human eye spectral sensitivity to the green color, the Bayer filter matrix comprises twice as many green elements as red or blue elements. Although the above structure gives adequate images, the pixel interpolation does not result in an optimal image quality.

### BRIEF DESCRIPTION OF THE INVENTION

An object of the invention is to provide an improved solution for creating color images. According to an aspect of the invention, there is provided an imaging device comprising at least two image capturing apparatus, each apparatus being arranged to produce an image, wherein at least one first apparatus comprises a color filter matrix of red and blue elements, and at least one second apparatus comprises a green color filter. The device further comprises a controller arranged to combine the images produced with the apparatus with each other to produce an image with an enhanced image quality.

According to another aspect of the invention, there is provided a method of creating an image file in an imaging device, comprising producing images with at least two image capturing apparatus, wherein at least one first apparatus comprises a color filter matrix of red and blue elements, and at least one second apparatus comprises a green color filter.

The method and system of the invention provide several advantages. One advantage of the invention is the improved image resolution obtained by the imaging device. Another advantage of the invention is the possibility to use the apparatus with the green color filter for capturing grayscale images.

### LIST OF DRAWINGS

In the following, the invention will be described in greater detail with reference to the preferred embodiments and the accompanying drawings, in which

FIG. 1 illustrates an example of an imaging device of an embodiment;

FIG. 2A and 2B illustrate an example of an image sensing arrangement, and

FIG. 3 illustrates an example of the structure of color filters;

FIG. 4 illustrates an example of a four-lens lenslet,

FIGS. 5A and 5B illustrate image sensor array arrangements and

FIG. 6 illustrates an embodiment of the invention.

### DESCRIPTION OF EMBODIMENTS

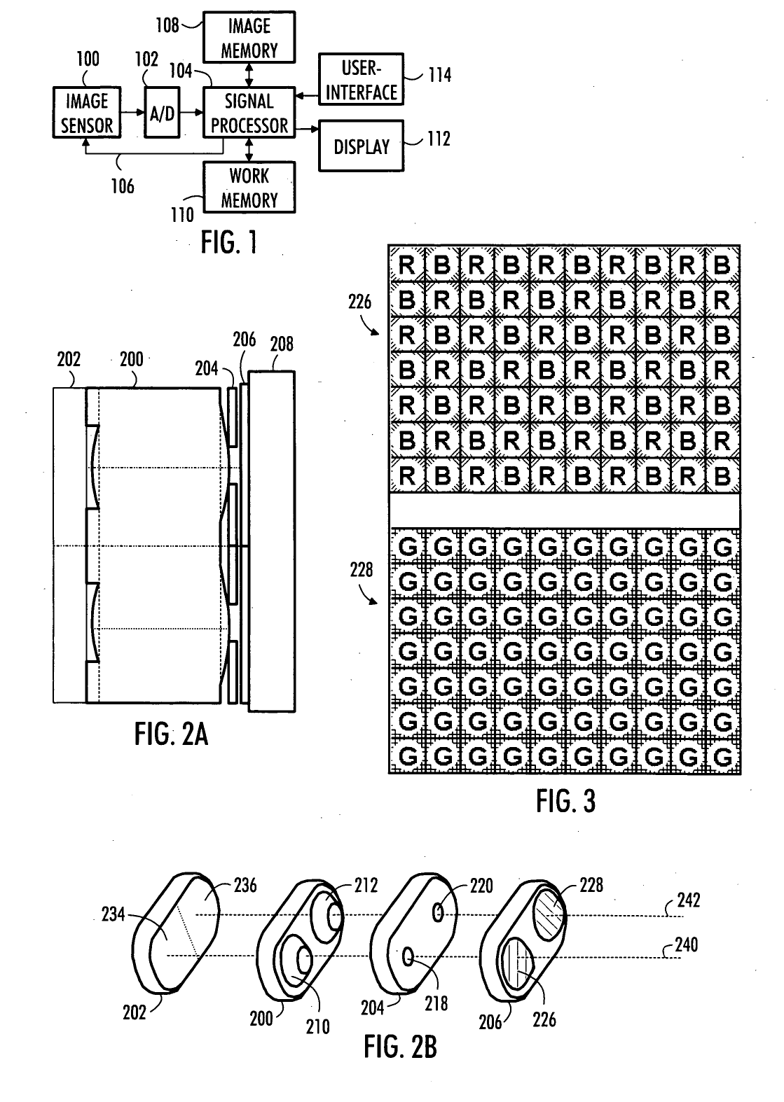

FIG. 1 illustrates a generalized digital image device which may be utilized in some embodiments of the invention. It should be noted that embodiments of the invention may also be utilized in other kinds of digital cameras than the apparatus of FIG. 1, which is just an example of a possible structure.

The apparatus of FIG. 1 comprises an image sensing arrangement 100. The image sensing arrangement comprises a lens assembly and an image sensor. The structure of the arrangement 100 will be discussed in more detail later. The image sensing arrangement captures an image and converts the captured image into an electrical form. The electric signal produced by the apparatus 100 is led to an A/D converter 102 which converts the analogue signal into a digital form. From the converter the digitized signal is taken to a signal processor 104. The image data is processed in the signal processor to create an image file. The output signal of the image sensing arrangement 100 comprises raw image data which needs post processing, such as white balancing and color processing. The signal processor is also responsible for giving exposure control commands 106 to the image sensing arrangement 100.

The apparatus may further comprise an image memory 108 where the signal processor may store processed images, a work memory 110 for data and program storage, a display 112 and a user interface 114, which typically comprises a keyboard or corresponding means for the user to give input to the apparatus.

FIG. 2A illustrates an example of image sensing arrangement 100. The image sensing arrangement comprises in this example a lens assembly 200 which comprises two lenses. The arrangement further comprises an image sensor 202, an aperture plate 204, a color filter arrangement 206 and an infra-red filter 208.

FIG. 2B illustrates the structure of the image sensing arrangement from another point of view. In this example the lens assembly 200 comprises two separate lenses 210 and 212. Correspondingly, the aperture plate 204 comprises a fixed aperture 218, 220 for each lens. The aperture plate controls the amount of light that is passed to the lens. It should be noted that the structure of the aperture plate is not relevant to the embodiments, i.e. the aperture value of each lens needs not be the same.

The color filter arrangement 206 of the image sensing arrangement comprises in this example a color filter for each lens. The color filter 226 of lens 210 comprises a color matrix of red and blue. The color filter 228 of the lens 212 comprises a single color filter of the green color. The sensor array 202 is in this example divided into two sections 234 and 236. Thus, the image sensing arrangement comprises in this example two image capturing apparatus 240 and 242. Thus, the image capturing apparatus 240 comprises the color filter 226, the aperture 218, the lens 210 and the section 234 of the sensor array. Correspondingly, the image capturing apparatus 242 comprises the color filter 228, the aperture 220, the lens 212 and the section 236 of the sensor array.

The image sensing arrangement of FIGS. 2A and 2B is thus able to form two separate images on the image sensor 202. The image sensor 202 is typically, but not necessarily, a single solid-state sensor, such as a CCD (Charged Coupled Device) or CMOS (Complementary Metal-oxide Semiconductor) sensor known to one skilled in the art. In an embodiment, the image sensor 202 may be divided between lenses, as described above. The image sensor 202 may also comprise two different sensors, one for each lens. The image sensor 202 converts light into an electric current. This electric analogue signal is converted in the image capturing apparatus into a digital form by the A/D converter 102, as illustrated in FIG. 1. The sensor 202 comprises a given number of pixels. The number of pixels in the sensor determines the resolution of the sensor. Each pixel produces an electric signal in response to light. The number of pixels in the sensor of an imaging apparatus is a design parameter. Typically in low cost imaging apparatus the number of pixels may be 640×480 along the long and short sides of the sensor. A sensor of this resolution is often called a VGA sensor. In general, the higher the number of pixels in a sensor, the more detailed image can be produced by the sensor.

The image sensor 202 is thus sensitive to light and produces an electric signal when exposed to light. However, the sensor is not able to differentiate different colors from each other. Thus, the sensor as such produces only black and white images. A number of solutions are proposed to enable a digital imaging apparatus to produce color images. It is well known for one skilled in the art that a full color image can be produced using only three basic colors in the image capturing phase. One generally used combination of the three suitable colors is red, green and blue RGB.

One solution used in single lens digital image capturing apparatus is to provide a color filter array in front of the image sensor, the filter consisting of a three-color pattern of RGB or CMY colors. Such a solution is sometimes called a Bayer matrix. When using an RGB Bayer matrix filter, each pixel is typically covered by a filter of a single color in such a way that in the horizontal direction every other pixel is covered with a green filter and every other pixel is covered by a red filter on every other line and by a blue filter on every other line. A single color filter passes through to the sensor pixel under the filter light which wavelength corresponds to the wavelength of the single color. The signal processor interpolates the image signal received from the sensor in such a way that all pixels receive a color value for all three colors. Thus a full color image can be produced.

In the multiple lens embodiment of FIG. 2A a different approach is used in producing a color image. The image sensing arrangement comprises a color filter arrangement 206 in front of the lens assembly 200. In practice the filter arrangement may also be located in a different part of the arrangement, for example between the lenses and the sensor. In an embodiment, the color filter 206 comprises separate filters, each filter in front of a different lens. The color filter 226 in front of the lens 210 comprises a color matrix of red and blue colors.

FIG. 3 illustrates an example of a structure of the color filters. The color filter 226 comprises a color matrix, where each matrix element acts as a separate color filter for a pixel on the image sensor 234. In the matrix, every other element is red and every other element is blue. Thus, every other pixel in the image sensor produces a signal responsive to the red color and every other pixel produces a signal responsive to the blue color. In FIG. 3, the red elements are marked with R and blue elements with B. The red and blue elements may also be in another order in the color matrix.

The color filter 228 in front of the lens 212 is of the green color. It may be realized with a single green filter or a color matrix where all elements are of the same color. FIG. 3 illustrates an example of a structure of the color filter 228 realized with a color matrix.

As illustrated in FIG. 2A, the lens assembly may in an embodiment comprise an infra-red filter 208 associated with the lenses. The infra-red filter does not necessarily cover all lenses, as it may also be situated elsewhere, for example between the lenses and the sensor.

Each lens of the lens assembly 200 thus produces a separate image to the sensor 202. The sensor area is divided between the lenses in such a way that the images produced by the lenses are not overlapping. The area of the sensor divided between the lenses may be equal, or the areas may be of different size, depending on the embodiment. The sensor 202 is a VGA sensor, for example. The size of the sensor is not relevant regarding the embodiments of the invention.

As described above, the electric signal produced by the sensor 202 is digitized and taken to the signal processor 104. The signal processor processes the signals from the sensor in such a way that two separate subimages from the signals of the lenses 210 to 212 are produced. The signal processor further processes the subimages and combines a VGA resolution image from the subimages.

In an embodiment, when composing the final image, the signal processor 104 may take into account the parallax error arising from the distances of the lenses 210 and 212 from each other.

The electric signal produced by the sensor 202 is digitized and taken to the signal processor 104. The signal processor processes the signals from the sensor in such a way that two separate subimages from the signals of the lenses 210, 212 are produced, another filtered with red and blue, the other with the green color. The signal processor further processes the subimages and combines a VGA resolution image from the subimages. The top left pixels of the subimages correspond to each other and differ only in that the color filter used in producing the pixel information is different. Due to the parallax error the same pixels of the subimages do not necessarily correspond to each other. In an embodiment the parallax error is compensated by an algorithm. The final image formation may be described as comprising many steps: first the two subimages are registered (also called matching). Registering means that any two image points are identified as corresponding to the same physical point). Then, the subimages are interpolated and the interpolated subimages are fused to an RGB-color image. Interpolation and fusion may also be in another order.

As one apparatus produces an image filtered with the green color, to which the human eye is most sensitive, the final composed image will have enhanced image resolution compared to images taken with prior art devices.

In embodiment of the invention, a lenslet with at least three image capturing apparatus is utilized. The image sensing arrangement comprises in this example a lens assembly 200 which comprises a lenslet array with four lenses.

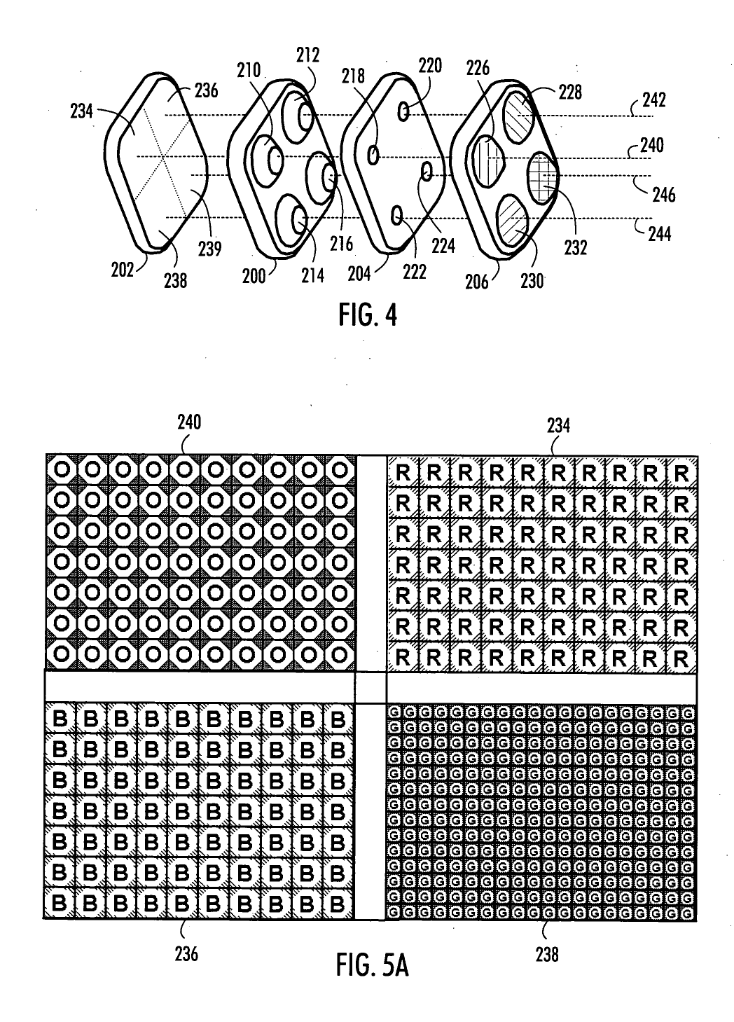

FIG. 4 illustrates the structure of an image sensing arrangement. In this example the lens assembly 200 comprises four separate lenses 210 to 216 in a lenslet array. Respectively, the aperture plate 204 comprises a fixed aperture 218 to 224 for each lens. The aperture plate controls the amount of light that is passed through the lens. It should be noted that the structure of the aperture plate is not relevant to the embodiments, i.e. the aperture value of each lens needs not be the same. The number of lenses is not limited to four, either.

The sensor array 202 is in this example divided into four sections 234 to 239. Thus, the image sensing arrangement comprises in this example four image capturing apparatus 240 to 246. Thus, the image capturing apparatus 240 comprises color filter 226, the aperture 218, the lens 210 and a section 234 of the sensor array. Correspondingly, the image capturing apparatus 242 comprises the color filter 228, the aperture 220, the lens 212 and the section 236 of the sensor array and the image capturing apparatus 244 comprises the color filter 230, the aperture 222, the lens 214 and the section 238 of the sensor array. The fourth image capturing apparatus 246 comprises the aperture 224, the lens 216 and the section 239 of the sensor array. The fourth apparatus 246 may or may not comprise a color filter 232.

The color filter arrangement 206 of the image sensing arrangement comprises in this example a red, green, blue filter and one optional filter. The optional filter may be used to enhance final image quality or the usage scope of the camera. The filters can be located on the sensor pixels, between the lens and the sensor, inside the lens system or in front of the lenses. In an embodiment, the red and blue sub-camera sensor areas are equal to the green sensor physical dimensions. The sensor for the green wavelength may have a smaller pixel size than the sensor areas for red and blue wavelengths. Thus, green channel resolution will be better because there are more pixels in the same physical area. The sub-camera lens for the green wavelength should be designed such that it is matched with better resolution.

The final image is composed by registering sub-images to each other. After that they are interpolated to the target size. The final color image is composed from the scaled images.

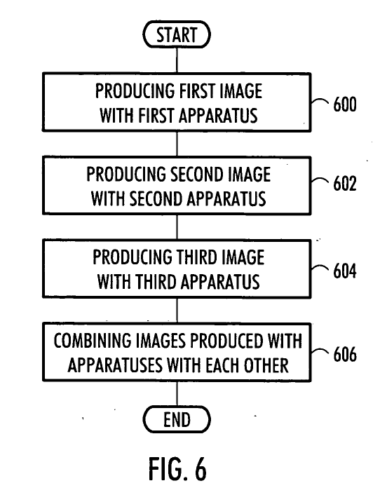

FIG. 6 illustrates an embodiment. In step 600, a first image is produced with a given resolution with a first apparatus comprising a red color filter. In step 602, a second image is produced with a given resolution with a second apparatus comprising a blue color filter. Step 604 comprises producing a third image with a given resolution with a third apparatus comprising a green color filter. The resolution of the third apparatus is higher than the resolution of the first and second apparatus. In an embodiment the steps 600 to 604 are executed simultaneously. In step 606 the images produced with the apparatus are combined with each other to produce an image with an enhanced image quality.

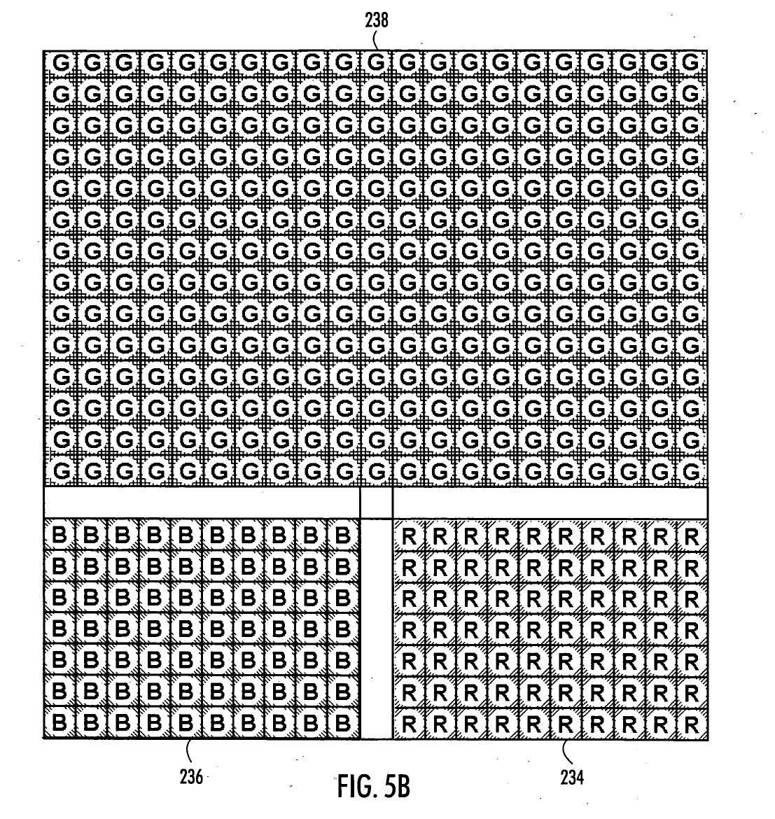

FIG. 5A illustrates an embodiment of the invention when a lenslet system with four lenses is utilized. The arrangement comprises thus four image sensing apparatus 240 to 246. The apparatus 240 is arranged to capture images through a red filter, the apparatus 242 is arranged to capture images-through a blue filter, and the apparatus 244 is arranged to capture images through a green filter. The fourth apparatus 246 is used for a special optional purpose. FIG. 5A shows the pixels of the image sensor 202. The sensor area is divided between the four image capturing apparatus. In FIG. 5A, the letters R, B, G and O denote the apparatus to which each pixel is allocated. The pixels of the section 234 are allocated for the apparatus 240 producing images through a red filter. The pixels of the section 236 are allocated for the apparatus 242 producing images through a blue filter. The pixels of the section 238 are allocated for the apparatus 244 producing images through a green filter. Finally, the pixels of the section 239 are allocated for the fourth apparatus 246.

The sensor areas of each apparatus are about equal, but the pixel size of the area 238 allocated for the apparatus 244 producing images through a green filter is smaller. In this example, the spatial resolution of the green area is two times higher compared to the other areas. Thus, the green channel resolution will higher. The lens of the image sensing apparatus 244 is designed to match the sensor area and the pixel size.

FIG. 5B illustrates another embodiment of the invention where a lenslet system is utilized. The FIG. 5B shows the pixels of the image sensor 202. The sensor area is divided between the image capturing apparatus. The letters R, B and G denote the apparatus to which each pixel is allocated. The pixels of the section 234 are allocated for the apparatus 240 producing images through a red filter. The pixels of the section 236 are allocated for the apparatus 242 producing images through a blue filter. The pixels of the section 238 are allocated for the apparatus 244 producing images through a green filter.

In this embodiment, the pixel sizes in each sensor area allocated to different apparatus are about equal. However, the area 238 allocated for the apparatus 244 producing images through a green filter is larger than the areas allocated for the apparatus producing images through red and blue filters. In this example, the size of the area 238 is twice the size of areas 234 and 236. Thus, the spatial resolution of the green area is two times better compared to the other areas and the green channel resolution is correspondingly higher. The lens of the image sensing apparatus 244 is designed to match the sensor area.

Even though the invention is described above with reference to an example according to the accompanying drawings, it is clear that the invention is not restricted thereto but it can be modified in several ways within the scope of the appended claims.

1. An imaging device comprising
at least two image capturing apparatus, each apparatus being arranged to produce an image, wherein at least one first apparatus comprises a color filter matrix of red and blue elements, and at least one second apparatus comprises a green color filter,
a controller arranged to combine the images produced with the apparatus with each other to produce an image with an enhanced image quality.

2. The device of claim 1, further comprising a controller arranged to produce a single color image from the image taken with the second apparatus.

3. The device of claim 1, wherein the second apparatus comprises a color filter matrix of green elements.

4. An imaging device comprising
a lenslet array with at least three image capturing apparatus, each apparatus being arranged to produce an image, wherein a first apparatus comprises a red color filter, a second apparatus comprises a blue color filter, and a third apparatus comprises a green color filter, each apparatus comprising an image sensor, wherein the image sensor of the third apparatus is larger than the image sensors of the first and second apparatus, and
a controller arranged to combine the images produced with the apparatus with each other to produce an image with an enhanced image quality.

5. The device of claim 4, wherein the image sensor of the third apparatus is at least twice as large as the image sensors of the first and second apparatus.

6. An imaging device comprising
a lenslet array with at least three image capturing apparatus, each apparatus being arranged to produce an image, wherein a first apparatus comprises a red color filter, a second apparatus comprises a blue color filter, and a third apparatus comprises a green color filter, each apparatus comprising an image sensor consisting of pixels, wherein the number of pixels in the image sensor of the third apparatus is larger than the number of pixels in the image sensors of the first and second apparatus, and
a controller arranged to combine the images produced with the apparatus with each other to produce an image with an enhanced image quality.

7. The device of claim 6, wherein the number of pixels in the image sensor of the third apparatus is at least twice as large as the number of pixels in the image sensors of the first and second apparatus.

8. A method of creating an image file in an imaging device, comprising
producing images with at least two image capturing apparatus, wherein at least one first apparatus comprises a color filter matrix of red and blue elements and at least one second apparatus comprises a green color filter.

9. The method of claim 8, further comprising: combining the images produced with the apparatus with each other to produce an image with an enhanced image quality.

10. The method of claim 8, further comprising: producing a single color image from the image taken with the second apparatus.

11. A method of creating an image file in an imaging device comprising a lenslet array with at least three image capturing apparatus, the method comprising
producing a first image with a given resolution with a first apparatus comprising a red color filter,
producing a second image with a given resolution with a second apparatus comprising a blue color filter,
producing a third image with a given resolution with a third apparatus comprising a green color filter, wherein the resolution of the third apparatus is larger than the resolution of the first and second apparatus, and
combining the images produced with the apparatus with each other to produce an image with enhanced image quality.
